(19) United States
(12) Patent Application Publication
(10) Pub. No.: US 2016/0028218 A1
(43) Pub. Date: Jan. 28, 2016

(54) TERMINAL SLEEVE STRUCTURE

(71) Applicant: Ming-Kun LI, Changhua (TW)

(72) Inventor: Ming-Kun LI, Changhua (TW)

(21) Appl. No.: 14/444,647

(22) Filed: Jul. 28, 2014

(51) Int. Cl. H02G 15/02

(52) U.S. Cl. CPC H02G 15/02

(57) ABSTRACT

A terminal sleeve structure contains: a body including a connector and an accommodating extension; a fitting sleeve including a diameter-decreasing segment formed on a first end thereof and a diameter-increasing segment arranged on a second end thereof; the cable including the plural core wires and an insulation layer. Before inserting the cable into the body, the insulation layer is stripped to expose the plural core wires, and the cable is inserted into the hollow accommodating extension from the diameter-increasing segment via the guiding loop. The guiding loop is fitted into the fitting sleeve from the diameter-increasing segment, the guiding loop includes a first opening defined on a first end thereof and a second opening defined on a second end thereof, a diameter of the second opening is greater than the first opening, the guiding loop further includes an arcuate guide face defined between the first opening and the second opening.

### FIELD OF THE INVENTION

The present invention relates to a terminal sleeve structure which contains a guiding loop including an arcuate guide face defined between a first opening and a second opening to guide plural core wires of a cable to insert into a hollow accommodating extension of a body.

### BACKGROUND OF THE INVENTION

Conventional terminal sleeve structure is used to connect a terminal and a cable together.

As shown in FIGS. 1 and 2, a terminal 10 contains a hollow accommodating extension 11 for inserting plural core wires 14 of a cable 13, and the hollow accommodating extension 11 is fitted with a first end of a fitting sleeve 12 which is made of rubber material or plastic material, and the cable 13 has an insulation layer. After the insulation layer is stripped, the plural core wires 14 of the cable 13 are inserted into the accommodating extension 11 of the terminal 10 from a second end of the fitting sleeve 12, and the accommodating extension 11 is clamped by a tool so that the terminal 10 and the accommodating extension 11 are positioned together.

However, the plural core wires 14 of the cable 13 are made of cooper material and expand outwardly after stripping the insulation layer, so the plural core wires 14 cannot be inserted into the accommodating extension 11 completely and easily.

Referring further to FIGS. 3 and 4, another conventional terminal 20 is fitted with a cable 24 through a fitting sleeve 22, wherein the fitting sleeve 22 has a diameter-decreasing segment formed on a first end thereof to accommodate a hollow accommodating extension 21 of the terminal 20, a diameter-increasing segment arranged on a second end thereof to accommodate the cable 24, and a guiding shoulder 23 defined between the diameter-decreasing segment and the diameter-increasing segment of the fitting sleeve 22. The diameter-increasing segment of the fitting sleeve 22 has an arcuate guide face defined on an end of an inner wall thereof opposite to the diameter-decreasing segment of the fitting sleeve 22. Hence, after the cable 24 is stripped, plural core wires 25 of the cable 24 are guided by the arcuate guide face of the guiding shoulder 23 to insert into the hollow accommodating extension 21 of the terminal 20 from the fitting sleeve 22.

Nevertheless, the guiding shoulder 23 of the fitting sleeve 22 is molded at a high cost, such as building mold, and the manufacturing efficiency is slow.

The present invention has arisen to mitigate and/or obviate the afore-described disadvantages.

### SUMMARY OF THE INVENTION

The primary object of the present invention is to provide a terminal sleeve structure which contains a guiding loop including an arcuate guide face defined between a first opening and a second opening to guide plural core wires of a cable to insert into a hollow accommodating extension of a body.

Another object of the present invention is to provide a terminal sleeve structure in which the guiding loop is manufactured at low cost and is applied to guide the plural core wires of the cable to insert into the hollow accommodating extension of the body smoothly.

To obtain the above objectives, a terminal sleeve structure provided by the present invention contains:

A terminal sleeve structure comprising:

a body including a connector and a hollow accommodating extension for inserting plural core wires of a cable;

a fitting sleeve including a diameter-decreasing segment formed on a first end thereof and accommodating the hollow accommodating extension of the body, the fitting sleeve also including a diameter-increasing segment arranged on a second end thereof and accommodating a guiding loop and the cable;

the cable including the plural core wires and an insulation layer for covering the plural core wires, wherein before inserting the cable into the body, the insulation layer is stripped to expose the plural core wires, and the cable is inserted into the hollow accommodating extension of the body from the diameter-increasing segment of the fitting sleeve via the guiding loop.

The guiding loop is fitted into the fitting sleeve from the diameter-increasing segment, the guiding loop includes a first opening defined on a first end thereof, and the guiding loop also includes a second opening defined on a second end thereof, and a diameter of the second opening is greater than the first opening, the guiding loop further includes an arcuate guide face defined between the first opening and the second opening to guide the plural core wires of the cable to insert into the hollow accommodating extension of the body.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view showing the exploded components of a conventional terminal sleeve structure.

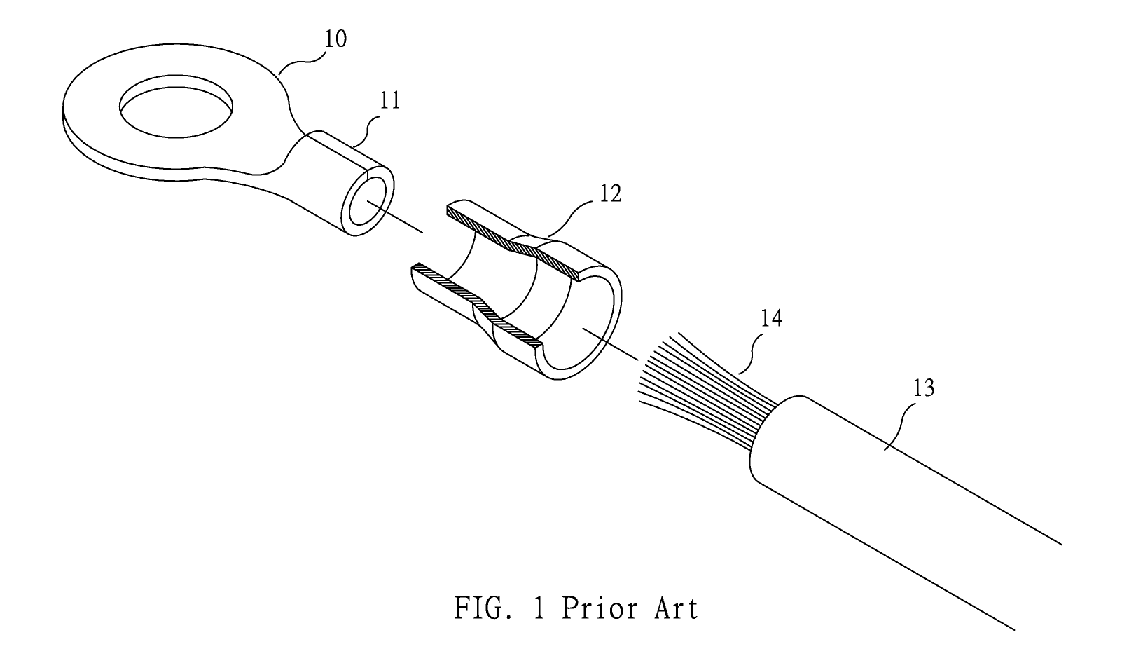

FIG. 2 is a cross sectional view showing the operation of the conventional terminal sleeve structure.

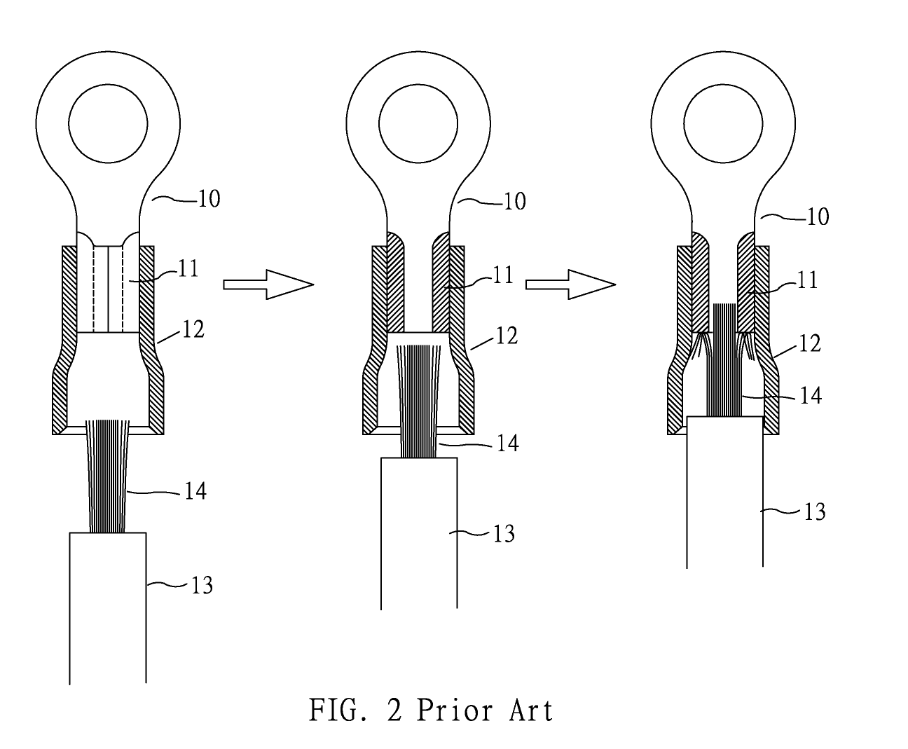

FIG. 3 is a perspective view showing the exploded components of another conventional terminal sleeve structure.

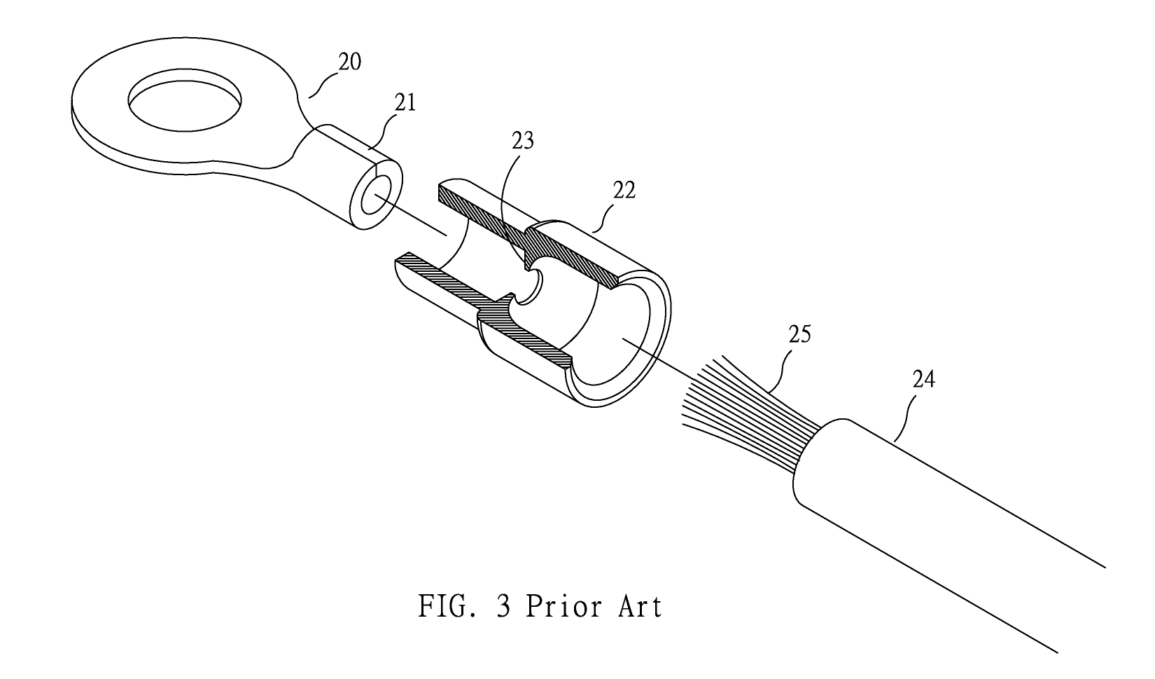

FIG. 4 is a cross sectional view showing the operation of another conventional terminal sleeve structure.

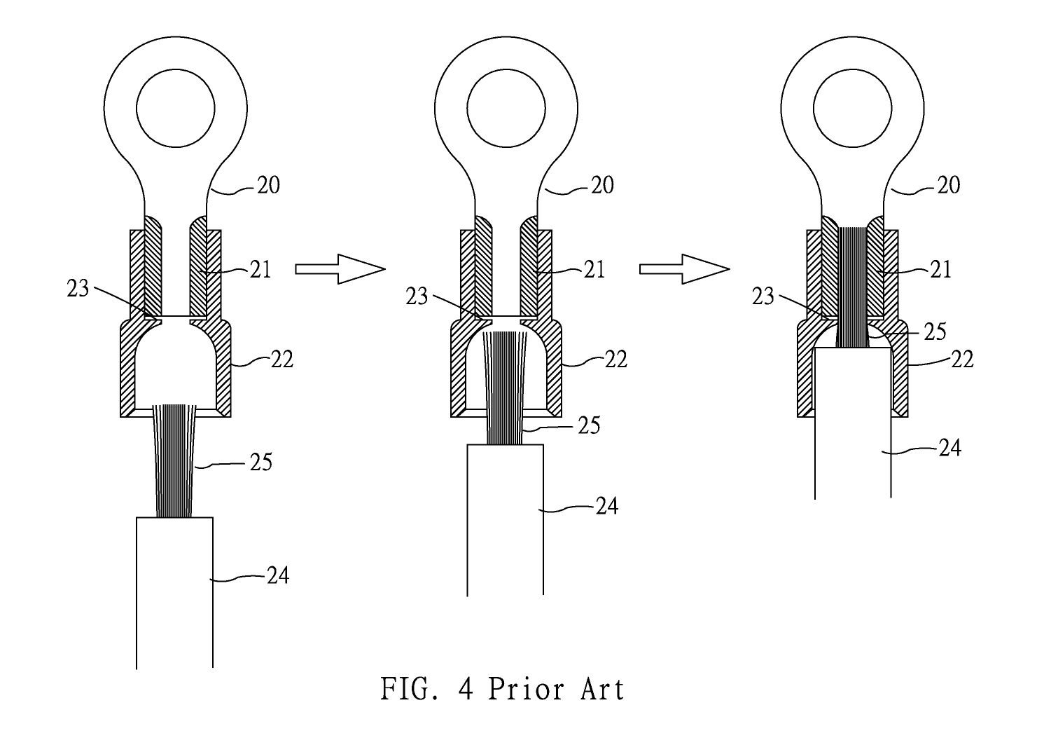

FIG. 5 is a perspective view showing the exploded components of a terminal sleeve structure according to a preferred embodiment of the present invention.

FIG. 6 is a perspective view showing the assembly of the terminal sleeve structure according to the preferred embodiment of the present invention.

FIG. 7 is a cross sectional view showing the operation of the terminal sleeve structure according to the preferred embodiment of the present invention.

### DETAILED DESCRIPTION OF THE PREFERRED EMBODIMENTS

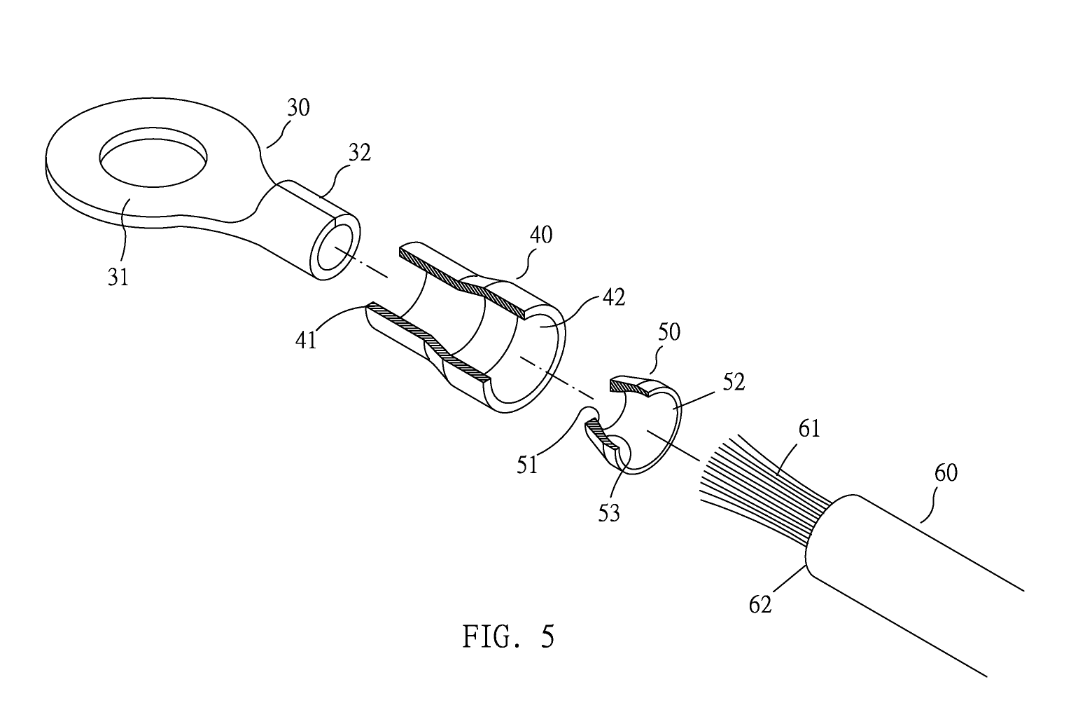

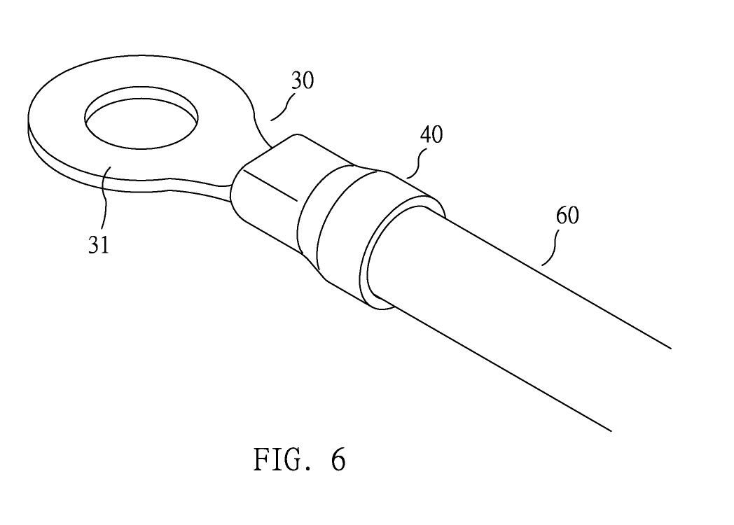

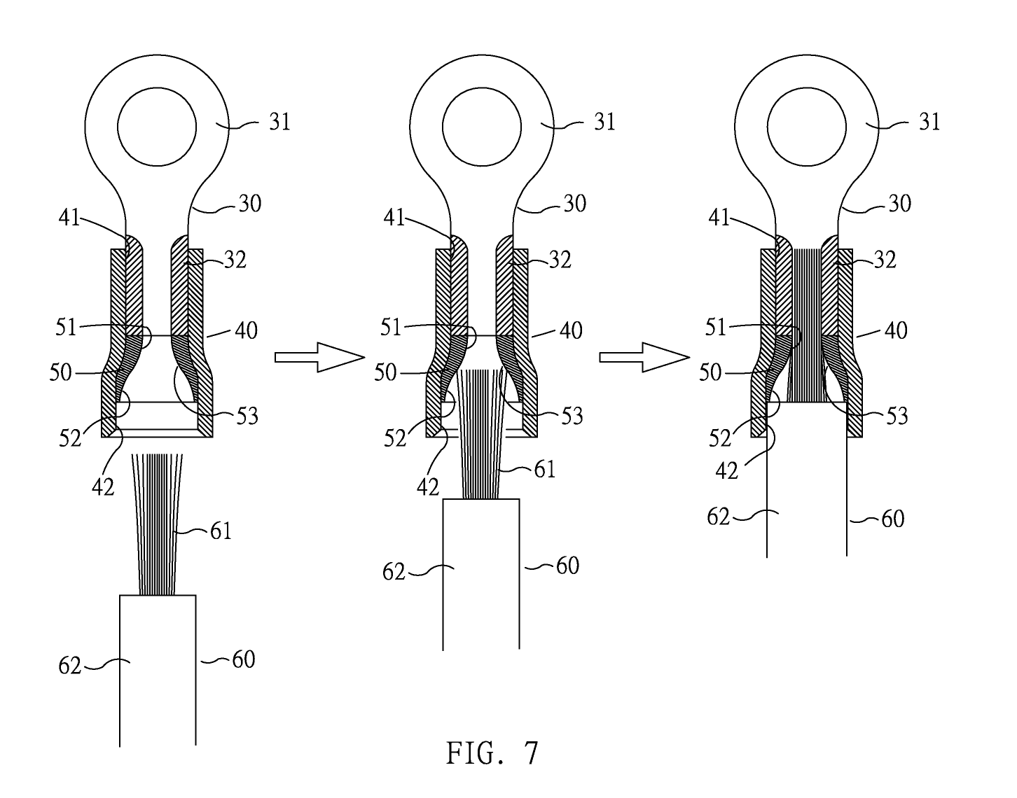

With reference to FIGS. 5 to 7, a terminal sleeve structure according to a preferred embodiment of the present invention comprises:

a body 30 including a connector 31 of various shapes, such as a circle shape or a Y shape, the body 30 also including a hollow accommodating extension 32 for inserting plural core wires 61 of a cable 60;

a fitting sleeve 40 made of rubber material or plastic material and including a diameter-decreasing segment 41 formed on a first end thereof and accommodating the hollow accommodating extension 32 of the body 30, the fitting sleeve 40 also including a diameter-increasing segment 42 arranged on a second end thereof and accommodating a guiding loop 50 and the cable 60;

the guiding loop 50 made of rubber material or plastic material and fitted into the fitting sleeve 40 from the diameter-increasing segment 42, the guiding loop 50 including a first opening 51 defined on a first end thereof, and a diameter of the first opening 51 being equal to or less than the hollow accommodating extension 32 of the body 30, the guiding loop 50 also including a second opening 52 defined on a second end thereof, and a diameter of the second opening 52 being greater than the first opening 51, the guiding loop 50 further including an arcuate guide face 53 defined between the first opening 51 and the second opening 52 to guide the plural core wires 61 of the cable 60 to insert into the hollow accommodating extension 32 of the body 30;

the cable 60 being a signal cable or a power cable and including the plural core wires 61 made of copper material or electricity conducting material, the cable 60 also including an insulation layer 62 for covering the plural core wires 61. Hence, before inserting the cable 60 into the body 30, the insulation layer 62 is stripped so as to expose the plural core wires 61, and the cable 60 is inserted into the hollow accommodating extension 32 of the body 30 from the diameter-increasing segment 42 of the fitting sleeve 40 via the guiding loop 50.

Thereby, the guiding loop 50 is fitted into the fitting sleeve 40 so that the first opening 51 abuts against the hollow accommodating extension 32 of the body 30, and since the diameter of the first opening 51 is equal to and less than the hollow accommodating extension 32 of the body 30, the plural core wires 61 of the cable 60 are guided by the arcuate guide face 53 of the guiding loop 50 to insert into the hollow accommodating extension 32 of the body 30 smoothly, and the hollow accommodating extension 32 of the body 30 is clamped by a tool, so the body 30 and the plural core wires 61 of the cable 60 are fixed together easily.

Furthermore, the guiding loop is manufactured at low cost and is applied to guide the plural core wires of the cable to insert into the hollow accommodating extension of the body smoothly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A terminal sleeve structure comprising:
a body including a connector and a hollow accommodating extension for inserting plural core wires of a cable;
a fitting sleeve including a diameter-decreasing segment formed on a first end thereof and accommodating the hollow accommodating extension of the body, the fitting sleeve also including a diameter-increasing segment arranged on a second end thereof and accommodating a guiding loop and the cable;
the cable including the plural core wires and an insulation layer for covering the plural core wires, wherein before inserting the cable into the body, the insulation layer is stripped to expose the plural core wires, and the cable is inserted into the hollow accommodating extension of the body from the diameter-increasing segment of the fitting sleeve via the guiding loop;
wherein the guiding loop is fitted into the fitting sleeve from the diameter-increasing segment, the guiding loop includes a first opening defined on a first end thereof, and the guiding loop also includes a second opening defined on a second end thereof, and a diameter of the second opening is greater than the first opening, the guiding loop further includes an arcuate guide face defined between the first opening and the second opening to guide the plural core wires of the cable to insert into the hollow accommodating extension of the body.

2. The terminal sleeve structure as claimed in claim 1, wherein a diameter of the first opening is less than the hollow accommodating extension of the body.
